(19) United States
(12) Patent Application Publication
(10) Pub. No.: US 2006/0236071 A1
(43) Pub. Date: Oct. 19, 2006

(54) Method and system for optimizing operations on memory device

(76) Inventors: Tomasz M. Barszczak, Fremont, CA (US); Kevin S. Sheehan, Palo Alto, CA (US); Chetan Rai, Palo Alto, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/106,857

(22) Filed: Apr. 15, 2005

(51) Int. Cl. G06F 9/34

(52) U.S. Cl. 711/204; 717/151; 717/152; 717/161

(57) ABSTRACT

A method and system for managing operation streams for multiple memory devices is presented. The method determines cross-dependencies among multiple operations and uses the cross-dependencies to optimize the execution of the operations. Also presented is a method of synchronizing memory devices with little adverse effects on system operations. The method entails sampling the objects in a predetermined order. Since the system is in normal use while the sampling is happening, an operation is received to be performed on at least one target object. A state of the target object is determined. If the target object is in a revising state, revision is performed on the second storage system and the operation is applied to the target object but its application to the second memory device is deferred until the target object is in its final state.

### TECHNICAL FIELD

The present invention relates generally to memory devices and particularly to managing the operations and contents of memory devices to optimize operations across input operation stream(s) over time.

### BACKGROUND OF THE INVENTION

A process that manages the operations on the contents of one or more memory devices (e.g., storage systems, databases, nodes) is used in various contexts including but not limited to file system operations, distributed computing, and databases. This process is useful in managing a single stream of operations in terms of optimization. It can also be used to manage multiple input streams of operations to output streams that are correct and optimized in varying circumstances.

For example, the problem of synchronizing the contents of multiple memory devices can be solved trivially by starting with identically blank or empty memory devices and adding identical data to each of the blank memory devices. The management process consists of propagating identical operations to each device. In practice, this simple synchronization method is of limited use because propagation of identical operations may not always be possible or contents may be lost during the process, resulting in asymmetric or non-identical contents.

There are (at least) two input streams to consider when dealing with the problem of synchronizing memory devices to make their content substantially identical. One input stream is the normal user operations made to a memory device, and the other input stream includes processes for comparing the memory devices and updating one of them to be substantially identical to the other. The goal of making the contents of multiple memory devices substantially identical is a moving target if both the normal operations and the synchronization process are occurring at the same time. A simple way to manage this process is to block normal operations while synchronization is taking place, eliminating the moving target. However, this simple way has the disadvantage of making the memory device unavailable for user operations for unreasonably long periods of time.

A method and system are needed to manage operations on memory devices so that operation streams can be executed correctly and efficiently, including but not limited to situations where the devices are being compared or synchronized.

### SUMMARY OF THE INVENTION

In one aspect, the invention is a method of optimizing a stream of operations. The method entails receiving a stream of operations, analyzing cross-dependencies among the operations, identifying a subset of the operations to be deferred and deferring the subset of the operations, and determining an optimized order for applying the subset of the operations that are deferred.

The method may be adapted for a system including more than one memory devices, or a system including multiple stream of operations. Where multiple memory devices and/or multiple operation streams are involved, an optimized order for applying the subset of the operations that are deferred to each of the memory devices is determined.

In another aspect, the invention is a method of optimizing streams of operations received by multiple memory devices having objects and corresponding objects. The method entails sampling the objects in a predetermined order, wherein the sampling changes the states of the objects. An operation to be performed on at least one target object of the objects is received, and a state of the target object is determined. The objects and the corresponding objects in the multiple memory devices are compared. Based on the state of the target object, the method determines the timing for applying the operation to the target object, and applying the operation to the second memory device. If the target object is in a revising state, the operation is applied to the target object but deferred for the second memory device.

In yet another aspect, the invention is a system for optimizing a stream of operations. The system includes a first module for receiving a stream of operations, a second module for analyzing cross-dependencies among the operations, a third module for identifying a subset of the operations to be deferred and deferring the subset of the operations, and a fourth module for determining an optimized order for applying the subset of the operations that are deferred.

The invention also includes a system for managing data between a plurality of memory devices. The system includes a first memory device having objects, a second memory device having corresponding objects, and an input for receiving an operation to be performed on at least one target object of the objects. A processor samples the objects in the first memory device, determines a state of the target object, determines whether to perform a revision, determines a timing for applying the operation to the target object, and determines a timing for applying the operation to the corresponding objects. If the target object is in a revising state, the processor applies the operation to the target object but defers applying the operation to the corresponding objects if the target object is in a revising state.

In yet another aspect, the invention is a computer-readable medium having computer executable instructions thereon for a the above-described method of managing data between a first storage system and a second storage system, and the above-described method of optimizing data processing.

### BRIEF DESCRIPTION OF THE DRAWINGS

FIG. 1 schematically illustrates a blocking synchronization process whereby a blocking region samples the objects of a first storage system.

FIG. 2 schematically illustrates a deferring synchronization process whereby a blocking region and a revising region sample the objects of a first storage system.

FIG. 3 depicts a file system with which the method of the invention may be used.

FIG. 4 schematically illustrates a parent-child list management process that is useful for keeping track of cross-dependencies for the multi-object operations.

FIG. 5 illustrates a ghosting process that uses a “ghost entry” to avoid missing an object during synchronization.

FIG. 6 illustrates that multiple operations may be ghosted and deferred.

FIG. 7 is an exemplary system that may be used to implement the methods disclosed herein.

### DETAILED DESCRIPTION OF THE EMBODIMENTS

The present invention will now be described in detail with reference to the drawings, which are provided as illustrative examples of the invention so as to enable those skilled in the art to practice the invention. The present invention may be implemented using software, hardware, and/or firmware or any combination thereof, as would be apparent to those of ordinary skill in the art. The preferred embodiment of the present invention will be described herein with reference to an exemplary implementation of a storage system going through a synchronization process. However, the present invention is not limited to this exemplary implementation. For example, the invention can be practiced in any computing system that includes multiple resources that may be provisioned and configured to provide certain functionalities, performance attributes and/or results. Aspects of the invention may also be used for contexts outside of data optimization and file system management, such as comparison and synchronization.

As used herein, a “memory device” is a device that is able to store information (e.g., metadata, data) in objects and allows the objects to be operated on (e.g., linked, created, deleted). A memory device may be a database, a file system, or a storage system but is not so limited. As used herein, “synchronization” is intended to indicate a process of making the data (meta data, visible data, attributes, etc.) between two or more systems substantially identical. An “operation” is a set of commands or instructions received from a user of the system such as Write, Remove, Link, and Rename. A “revision” is a set of edits made to a second memory device to make its content match that of the first memory device, and differs from “synchronization” primarily in that application of a new operation is not involved. An “object” refers to a part of the data that is stored in a memory device. In a memory device with block level (also called volume level) structure, an object could be a block of data. In a memory device with file system structure, an object could be a directory, subdirectory, or a file. In some cases, an object could be multiple blocks of data or multiple directories/files.

FIG. 1 schematically illustrates a blocking synchronization process 10 whereby a blocking region 12 samples the objects 14 of a first memory device in the direction indicated by an arrow 16. As the blocking region 12 samples the objects 14, it covers some of the objects 14 and puts them in a blocking state. As the sample continues, different objects 14 are in the blocking state. Objects 14 that have not been sampled yet are in an initial state, and objects 14 that have been sampled are in a final state. A sampling run ends when each of the objects 14 is in the final state. At least theoretically, the objects 14 are synchronized with a second storage device at the end of the sampling run.

The memory device being in normal operation while the blocking synchronization process 10 happens, operation commands are received during synchronization. An operation is directed to at least one target object of all the objects 14. If the target object is in its initial state, the operation is applied only to the first memory device and not to the second memory device. No comparison with the second memory device is made in the initial state. If the target object is in a blocking state around the time the operation is received (e.g., the target object is covered by the blocking region 12), the operation is blocked. The operation remains blocked until the continuing sampling process takes the target object out of the blocking state and into its final state. In this blocking state, any revision that is needed to make the corresponding objects in the second memory device substantially identical to the target objects in the first memory device is made. This revision process could be time-consuming. If the target object is in its final state, the operation is performed on the first memory device and the same operation is replicated to the second memory device.

One of the problems with the blocking synchronization process 10 is that operations can remain blocked for too long a time. One of the reasons is because the revision process that occurs in the blocked state can take a long time. Operations can remain blocked for a long time especially if the blocking region 12 is large. Although shrinking the size of the blocking region 12 may seem like a solution to this problem, this adjustment often has the undesirable effect of slowing down the overall synchronization process. The slowness of the synchronization process is especially problematic when latency (the round-trip time for transmitted data) between the two memory devices is high.

The blocking synchronization process 10 raises additional problems if the objects 14 are in a file system that is organized in files and directories. For example, achieving complete synchronization becomes challenging if an operation moves a file from a directory in the initial state to a directory that is in its final state. By the time the blocking region 12 gets to the object from which the file was removed, there is no file to be copied there. However, since the file is now in the directory that is in the final state, the blocking region 12 will not re-visit the final state. The effect is a “missed object” situation wherein file that was moved in the middle of the synchronization process is completely missed. Although the “missed object” situation can be avoided by blocking all operations until all the objects are in their final states, this blanket “lock” is undesirable for the obvious reason that many operations might end up being blocked for an unreasonably long time. Even simple operations could be blocked as a result of this “lock” being placed on the affected objects.

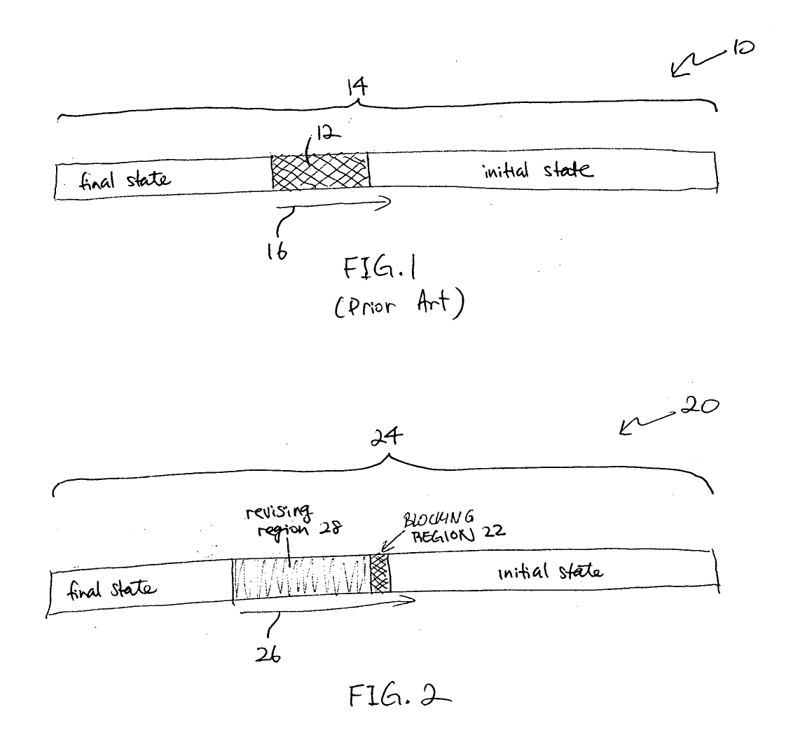

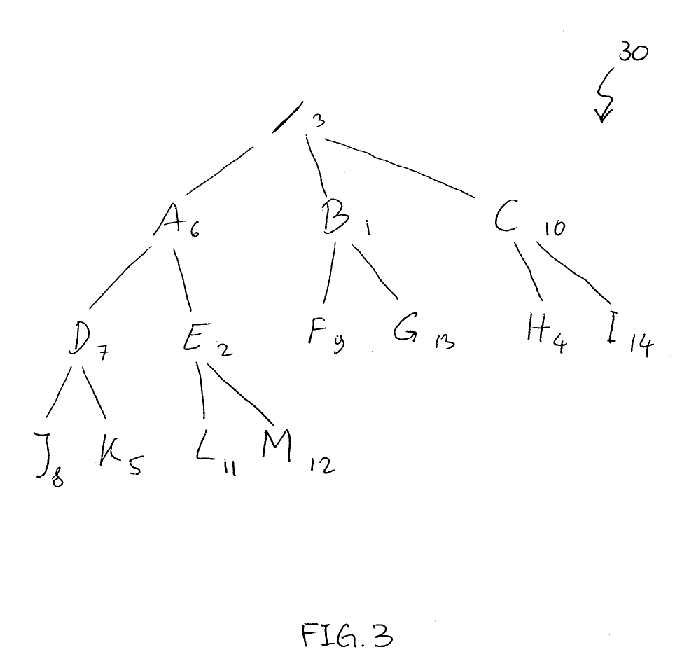

FIG. 2 schematically illustrates a deferring synchronization process 20 in accordance with the invention. In the deferring synchronization process 20, operations are blocked in a smaller region and for a shorter period of time compared to the blocking synchronization process 10. Unlike in the blocking synchronization process 10, where the revision process happens while the operations are blocked, the deferring synchronization process 20 separates out the revision process from the blocked state, allowing operations to be accepted (as opposed to blocked) during the potentially time-consuming revision process. As a result, in this deferring synchronization process 20, operations are blocked only long enough to gather the information needed and to compare the contents between the two memory devices.

This separate revision process is achieved by implementing a revising region 28 that is separate from the blocking region 22. The objects 24 that are covered by the revising region 28 are in a revising state, which is the transition state between the blocking state and the final state. The revising region 28 and the blocking region 22 are preferably adjacent to each other, with the blocking region 22 preceding the revising region 28.

No revision or operation is performed to an object that is in the blocking state. Objects 24 in the initial state are treated similarly to the objects 14 in their initial state, as described above. Likewise, objects 24 in their final state are treated similarly to the objects 14 in their final state. The second memory device is revised during the revising state to make the corresponding objects in the second memory device match that of the target object. Any operations received in the revising state is accepted but deferred until the final state. Thus, in the final state, the deferred operations and any newly received operations are applied both to the objects 24 and the corresponding objects in the second memory device.

The blocking region 22 and the revising region 28 convert the objects 24 in their initial state to the objects 24 that are in their final state. The blocking region 22 and the revising region 28 sample the objects 24 in the direction indicated by an arrow 26. The blocking region 22 is preferably adjacent to the revising region 28 so that an object that comes out of the blocking state immediately enters the revising state. Two types of changes are made to the objects that are in the revising state: 1) any revisions needed to make these objects substantially identical to the corresponding objects in the second memory device, and 2) any recently received operations. Making the revisions entails comparing the first memory device against the second memory device. Most of he changes made to the objects 24 in the revising state are applied only locally and no changes are applied to the second memory device in this state. However, the changes are remembered (e.g., cached) and deferred until the objects 24 are in their final state, at which point they are applied to the second memory device.

The blocking region 22 moves forward in the predetermined sample path according to its own process or thread. After the objects 24 are out of the revising state and in their final state, the queued deferred operations are transmitted to the second memory device (i.e., the deferred operations are “played”). Once the objects 24 are in their final state, any incoming operations received afterwards are applied to the first memory device and the second memory device without deferral.

While the objects 24 are in this potentially time consuming revising state, they remain available to accept new operations. Thus, the number of objects that are in the revising state at a given time may be made quite large without the concern of making a large part of the first memory device unavailable for operations.

The usefulness of the deferring synchronization process 20 is enhanced by the fact that the deferred operations take up only a small memory space. The process 20 is efficient with memory space usage because it is not necessary to store (e.g., in cache) all the changes made in the revision state. Instead of storing the changes made, just the object identifier, names in the operation, operation span, and attributes involved in the operation need to be remembered. For example, if it is a Write operation that is deferred, only the offset and length of the write has to be stored, not the entire written data. When the affected objects reach their final state and the deferred Write operation is played, the synchronization code replicates the indication portion of the data from the first memory device.

To some extent, the number of deferred operations can be limited by slowing down the incoming operations, for example by using the method described in U.S. patent application Ser. No. 10/997,198 titled “System and Method for Managing Quality of Service for a Storage System” filed on Jan. 24, 2005, the content of which is incorporated by reference herein. Another way of slowing down incoming operations may be to play back the deferred operations in the context of a thread that allows for adding more deferred operations. The number of deferred operations may also be limited by adjusting the size of the revising region 28.

Some of the revisions and/or the deferred operations may be performed in threads. By using threads, more revisions and/or deferred operations can be easily added without creating confusion.

Information other than the four states mentioned above may be tracked for various purposes. For example, if the synchronization process revises a content of a directory by first creating all missing objects in the directory and then deleting any remaining extra objects in that directory, we can split this revising state into two phases: a creation phase and a deletion phase. Then, if a Remove operation is received after the creation phase has passed, we can immediately replicate the operation to the second memory device without deferring even though the affected objects are still in the revision state. There is no need to remember the deferred operation in such case because the necessary objects have been created and the Remove operation that is sent to the second memory device can succeed. If the replication were to be done before the creation phase is complete, the operation may have failed because the object to be removed may not have been created yet.

The state information can be kept persistently in the memory device but it is more practical to keep it only transiently in a cache memory. Extra state information can be kept to help determine a state for newly cached objects, or to prevent removing the objects that are involved in the synchronization process from cache. It is possible to have objects that become cached after the synchronization process already started, and these objects ill have an incomplete synchronization state because the position of the object with respect to the progress of the traversal will not be known. Without knowing the object's position with respect to the traversal, it is difficult to determine what state should be assigned to the object. For objects with incomplete synchronization state information, deferred operations may be played at the end of the synchronization process. Deferred operations for objects with incomplete synchronization state may be discarded if the objects are subsequently decided to be in the initial state.

An operation may involve multiple objects. For example, a Rename operation involves the renamed child object, the old parent directory, and the new parent directory. In this case, the states of all objects are considered when making the decision about how to handle the received operation. For example, as will be described below, cross-regional operations are deferred even when none of the affected objects is in the revising state (e.g., even when one parent is in the initial state and other parent is in the final state).

When deciding how to handle a newly received operation, any previously deferred operations are considered in addition to the state of the affected object. A previously deferred operation may cause a deferral of a new operation even if the affected object is not in a revising state, as will be described below.

An object state may be affected not only by the synchronization process but also by an operation. For example, a file with multiple hard links may transition from a final state back to an initial state when the last link in the final state revising region is removed and all the remaining links are in the initial state.

After the deferring synchronization process 20 is completed, all objects are in the final state. If, at a future time, another synchronization process is to be performed, the state-indicator flag can be flipped so that the signal that used to indicate the final state now indicates the initial state, and vice versa. This way, the hassle of visiting every object and changing each of its states can be avoided.

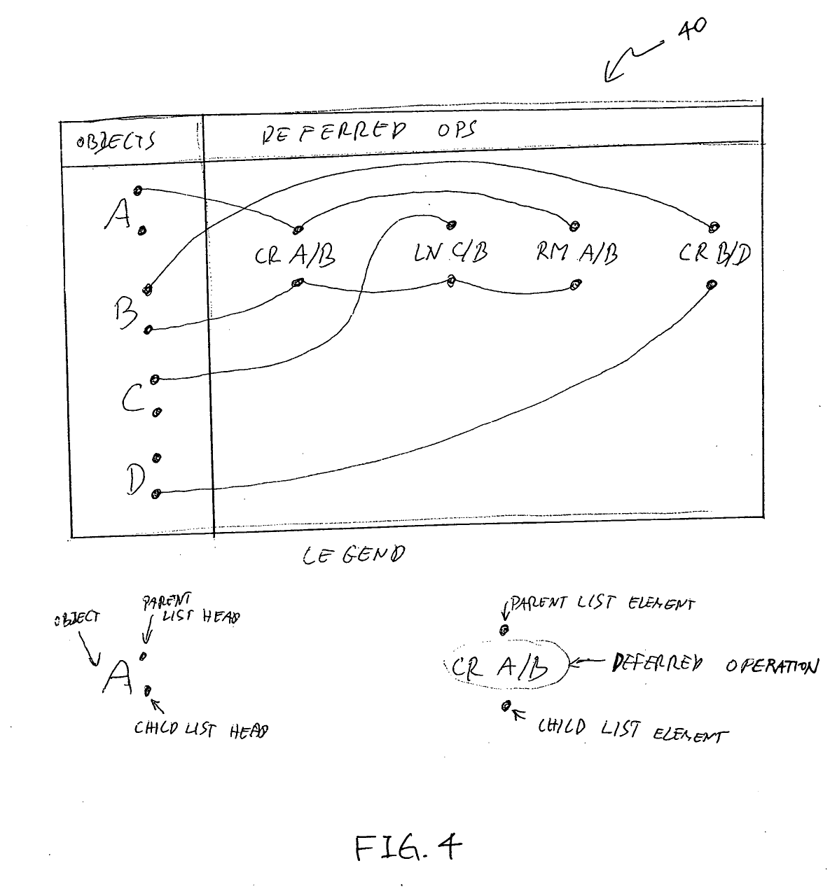

FIG. 3 depicts a file system 30 that with which the method of the invention may be used. The exemplary file system 30 includes directories (A, B, C) and sub-directories (e.g., D, E). The “leaves” in the file system “tree” such as F, G, H, I, J, K, L, and M may be subdirectories or files. Each file and directory (including subdirectory) is associated with a unique numerical identifier (shown in subscripts). In a first embodiment, the objects 24 are ordered according to the file numerical identifier. Thus, the blocking region will begin its sample starting with B₁, then move on to E₂,/₃, H₄, K₅, and so on. In a second embodiment, the objects 24 are ordered according to their depth, such that the sample starts with/and goes to A-D-J-K-E-L-M-B- . . . . In a third embodiment, the blocking region samples according to the breadth of the metadata, such that the sample begins with/and advances in the order of A-B-C-D-E-J-K-L-M-F- . . . . These are just exemplary methods of ordering the objects 24 and not intended to be an exhaustive list of possibilities.

As mentioned above, an “object” could be a block of memory space. A block level synchronization would sample the blocks in the low level block device.

Cross-Dependency Between Deferred Operations

Playing of the deferred operations can be complicated by cross-dependencies between the deferred operations. For example, if we defer the Create operation of a subdirectory B in directory A (A/B) and the Create operation of a sub-subdirectory C in the subdirectory B (B/C), the latter operation can only be played after the former operation. Even if B and C were in their final states, the B/C operation cannot be performed until the A/B operation is performed. In a case like this, it is important to know that there is the B/C operation waiting to be played when directory A changes its state such that the A/B operation can be performed. With many deferred operations, and especially with many deferred multi-object operations, a method for keeping track of the cross-dependencies would be useful. The goal is to play the operations in the order that respects the cross-dependencies, and to play the operations as soon as possible so no operation is deferred for an unnecessarily long time.

One way to address the cross-dependency issue is to classify the operations into two groups: a simple operation and a multi-object operation. A simple operation, such as Write, an attribute change, or a truncation, only involves a single object. A multi-object operation, such as Create, Remove, Link, or Rename, include multiple objects. (“Remove” involves multiple objects because the removed child object and its parent object are affected.) Simple operations are queued up for the target object in a sequential manner, e.g. in the order of arrival. Multi-object operations are organized using the parent-child management process described below.

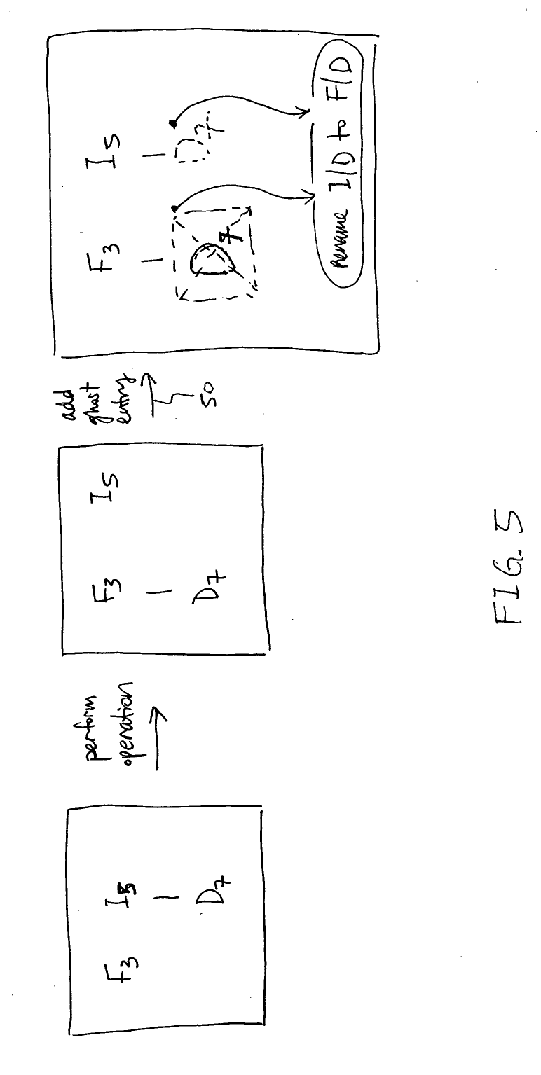

FIG. 4 schematically illustrates a parent-child list management process 40 that is useful for keeping track of cross-dependencies in multi-object operations. Each object has a parent list and a child list. The parent list lists the operations in which the particular object is treated as a parent, and the child list lists the operations in which the particular object is treated as a child. Each deferred multi-object operation is added to a parent list for the parent object and a child list for the child object. A “parent” object refers to the object that is higher up in the file system and includes a “child” object.

In the particular example in FIG. 4, three operations are received: Create A/B (Cr A/B), Rename A/B as C/B, and Create B/D (Cr B/D). The Rename operation can be divided into two sub-operations: Link C/B (Ln C/B) and Remove A/B (Rm A/B). As indicated by the legend in FIG. 4, A, B, C, and D indicate the objects. The upper dot in the “colon” next to the object identifier represents a parent list for the particular object, and the lower dot in the “colon” represents the child list. The lines connecting the dots in the “colon” to the four operations indicate which list(s) each of the operations appear in. For example, the upper dot for object A being connected to Cr A/B and Rm A/B shows that object A is the parent directory in these two operations. The fact the lower dot for object A is not connected to any operation indicates that object A is not a child object in any of the currently deferred operations.

In the case where an object transitions to the final state and enables some of its deferred operations to be played (as opposed to the case where the operation can be played before the object transitions to its final state, as described above), the first operations on its parent list and child list are examined to make sure the playback of the operation is not blocked. For example, let's suppose the object B in FIG. 4 transitioned to its final state. The system looks at object B's parent list to see that Cr B/D is the first (and in this case, only) operation on its deferred operations list. The system checks object D to see if this operation is also the first operation in line for object D, and in this case it is. However, when the system checks object B's child list in a similar manner, it becomes clear that the operation Cr B/D cannot actually be played until the subdirectory B comes into existence through the operation Cr A/B. Thus, Cr B/D is prepared to happen as soon as Cr A/B happens.

Let's now suppose object C transitioned to its final state. Checking object C's parent list, the system sees that Ln C/B is the first on its list. However, when object B's child list is checked to see if the operation Ln C/B is first on its list, it is not. The operation Cr A/B is blocking the Ln C/B operation on B's list. Thus, the operation Ln C/B is further deferred until operation Cr A/B is completed, even though object C is in its final state.

When an object's deferred operation is played, the parent and child lists of that object are examined to see if any other operation that was blocked is now playable. If the second item on the list of playable, it is played and the third item is examined. The exam-and-play routine continues until the next deferred operation on the list is not playable.

To avoid unnecessary blocking and to avoid creating meaningless dependencies, a single object may have multiple parent lists and/or multiple child lists. For example, where Create A/B and Create A/C are two operations for object A, it is preferable to split the operations up between two lists because one does not have to happen before the other. Putting both operations in a single list would force them to be ordered, creating an unnecessary dependency.

Besides the rules associated with the child-parent lists described above, there may be additional rules for determining the order in which deferred operations are played. For example, a Create operation for any object must play before any other operation on this object, since there has to first be an object to operate on. For a similarly logical reason, Removal of an object should be played only after all other operations on the object has been played.

In order to reduce the number of deferred operations to be remembered, and to reduce the complexity of the cross dependencies, some deferred operations can be combined into one deferred operation. For example, Rename A/B to C/B followed by Rename C/B to D/B can be consolidated into a single Rename A/B to D/B operation. In some cases, some deferred operations can be discarded. For example, a sequence of Create A/B, Write to B, and Remove A/B can be completely discarded, since you end up in the same place you started. If there is a time stamp update on the parent directory A, the time stamp may be saved. Besides these specific examples, there are numerous other cases for combining operations, and suitable rules may be created. Adjacent Write operations may be combined into a single Write operation, Write operations followed by a Truncate operation that erases the Write may be discarded, a series of operations that change object attributes (e.g., permissions) may be replaced by a single operation that sets the final object attributes.

The above-described method of managing cross-dependencies between deferred operations is applicable in any situation where operations are stored prior to being applied, and when they can be applied in an order that is different from the order in which the operations arrived. For example, the method may be an intent log of operations to be applied in an underlying file system or disk, or it could be intent log of operations waiting to be replicated to a remote system. A concrete example is the Persistent Intent Log (PIL) described in U.S. patent application Ser. No. 10/866,229 filed on Jun. 10, 2004, the content of which is incorporated by reference herein. Although storage system synchronization is one example of the method's application, this implementation is not meant to be limiting.

The cross-dependency management prevents application of the operations from causing errors (e.g., a parent does not exist when a child is created), and ensures that a correct result is achieved by applying the operations. More specifically, the cross-dependency management enables the following:

1. determining when an operation cannot be immediately applied;

2. when a particular operation is applied, determining what other operations that were blocked by the particular operation can now be applied;

3. based on 1 and 2, determining the minimum set of operations that are blocked or the maximum set of operations that can be applied; and

4. identifying deferred operation candidates that can be combined for efficient execution.

Ghosts

Sometimes, a multi-object operation that affects both an object in the final state or the revising state and an object in the initial state occurs during the synchronization process. As explained above, this can result in a “missed object” situation (e.g., where a file is moved from a directory that is not yet visited to a directory in its final state). For example, suppose the operation Rename I/D to F/D is received, wherein the directory I is in the initial state and the directory F is in the final state. When this operation is performed, the file D is removed from the yet-unsampled directory I and added to the already-sampled directory F. A problem with this situation is that file D will be completely missed during the synchronization process because it will not be in directory I when the directory I is sampled. Although the file D is in directory F, directory F was sampled before file D was there and will not be revisited.

Alternatively, a “multiple visit” situation could arise as a result of a multi-object operation that occurs during synchronization. The “multiple visit” situation arises where a file is moved from a directory that has already been visited to a directory in its initial state. The file will be visited twice in this situation—first in the old directory and second in the new directory. Problems like “missed object” or “multiple visit” can become greater in magnitude if the object that is moved is a directory or a subdirectory rather than a file.

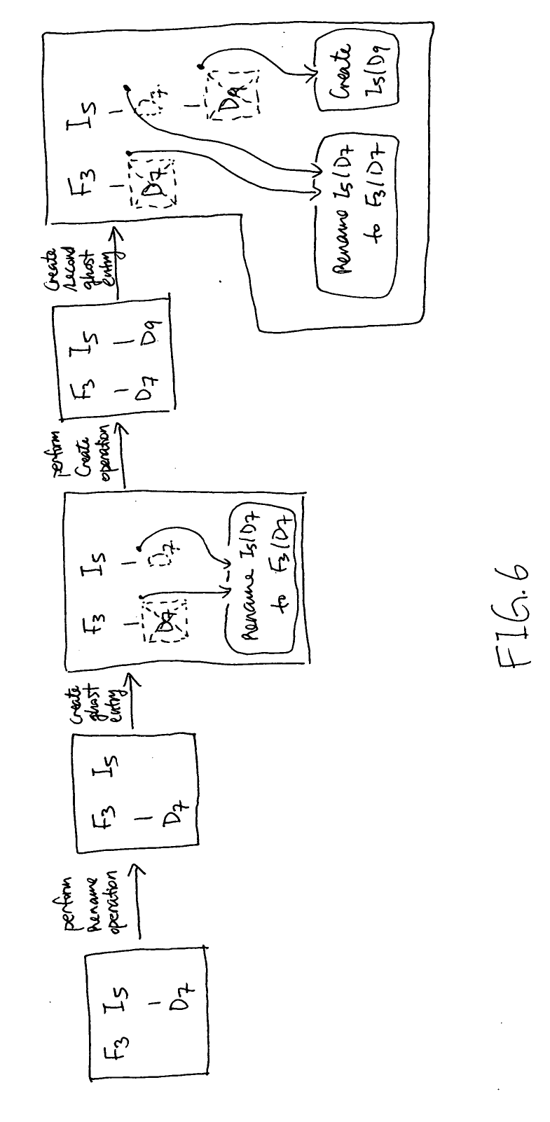

FIG. 5 illustrates a ghosting process 50 whereby a “ghost entry” of an updated object is used to avoid the “missed object” situation. A ghost entry is a marker for the synchronization process indicating either that there is an object in its spot or there is no object in its spot, regardless of whether there is really an object there or not. The ghost entry is invisible to the normal file system operations, and is only visible to the synchronization process. Thus, to the synchronization process that sees the ghost entries, the objects look the way the ghost entries describe them.

Two kinds of ghost entries may be used: a positive ghost entry and a negative ghost entry. A positive ghost entry is used for an object that was there before the operation but was removed during the operation. The positive ghost entry makes the synchronization process think that the object is still where the ghost entry is. A negative ghost entry is used for hiding an object that appeared under the new name due to the operation. The negative ghost entry is used for making the synchronization process think that the object that is there is not there.

FIG. 5 illustrates the use of ghost entries to avoid the missed-object situation even when an operation affecting an initial state object and a final state object is received in the middle of a synchronization process. When operations happen to an object (e.g., I/D) that is ghosted, the operations are deferred and ghosted as well. For each object, there may be a series of ghost entries. Only the oldest ghost for a given child name is visible to the synchronization process. Then, as the deferred operations are played, their ghost entries are removed and the next ghost entry becomes visible.

In the exemplary case of FIG. 5, there is an independent object F₃, a parent object I₅, and a child object D₇ in the parent object I₅. An operation Rename I/D to F/D is received and performed, so that the child object D₇ is now in the parent object F₃ instead of the parent object I₅. To avoid the object D₇ from being completely missed, the object D₇ is ghosted. A negative ghost entry is made under the object F₃ to hide the object D₇ that is there, and optionally, a positive ghost entry is made in the object I₅ to make the synchronization process think that the object D₇ exists in the object I₅. Both of the ghost entries are associated with the ghosted and deferred Rename so that at the end of the synchronization process (i.e., after all the deferred operations are played), the file D will appropriately appear in the parent object F.

FIG. 6 illustrates that multiple operations may be ghosted and deferred. In the example of FIG. 6, a Create I₅/D₉ operation is added to the ghosted state at the end of FIG. 5. This operation is performed by creating a new child object D₉ in the parent object I₅. The newly formed child object D₉ is then negatively-ghosted so that it is hidden from the synchronization process, ad a link is made to the deferred and ghosted Create operation. At the end, there are two ghosted and deferred operations associated with the objects D₇ and D₉. There is a cross-dependency between the two operations and D₇ should be renamed before D₉ is created (otherwise, D₉ will be moved with D₇). The two operations will be performed in the proper order using the parent-child list management process described above in reference to FIG. 4.

For one parent, there may be a separate list of ghost entries for each unique child name. For example, when the file B is renamed from A/B to X/B, a ghost entry may be created for parent A pertaining specifically to the file name B. If a file C is renamed from A/C to Y/C, a second list is formed for the parent directory A, this second list being specific to file C and separate from the list that is specific to file name B. If, later, a new file B is created (with a different file identifier than the previous file that was called B), another ghost entry is added to the list that pertains to file name B.

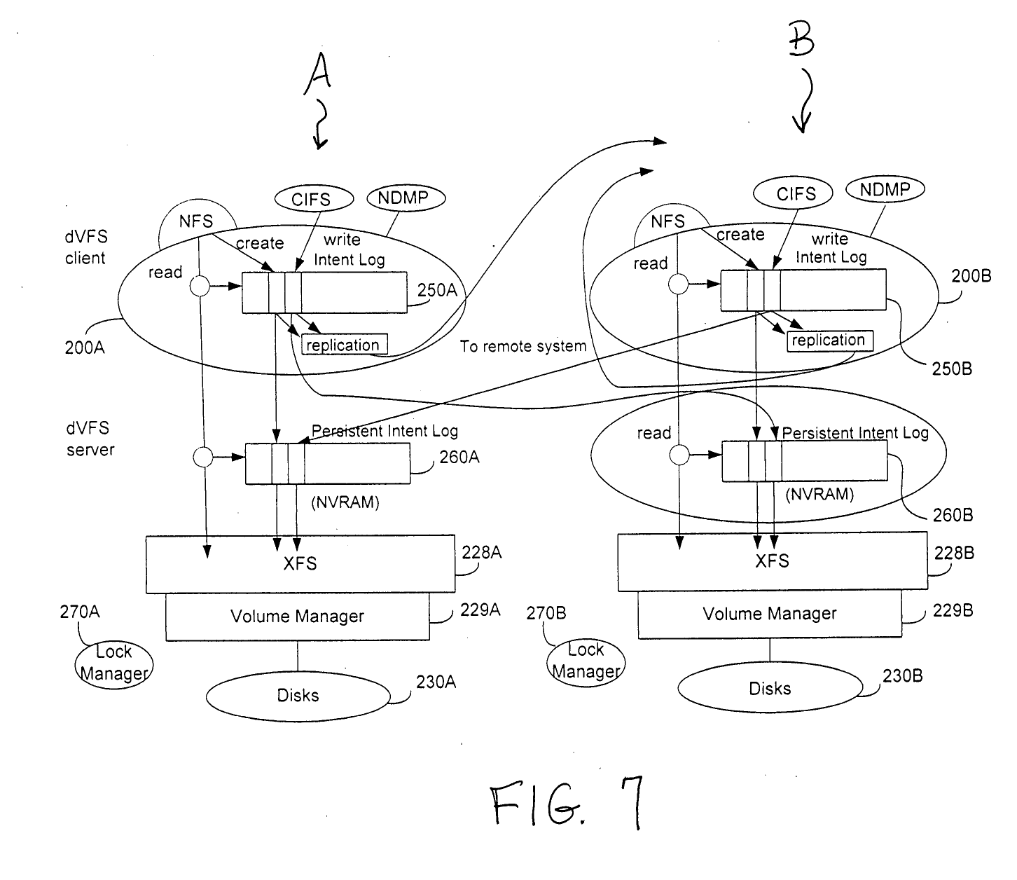

FIG. 7 illustrates an exemplary embodiment of a memory device A, which in this case is a storage system. Operations coming from clients (NFS, CIFS, local applications, or even internally generated operations, etc.) through various protocols or APIs, prior to applying them in a back-end storage 228A, are stored in Intent Log 250A and in Persistent Intent Log 260A. Cross-dependencies between stored operations are recorded as described above. Operations are applied to the back-end storage 228A in parallel (i.e., concurrently) and generally out of order (i.e., in an order different from the order of arrival) to achieve the optimum performance. Cross-dependencies between operations enable the system to figure out which operations can be applied at any given time and which operations are blocked by other operations that have not yet been applied. As operations are applied, the cross-dependencies allow the system to find which operations can be applied next (as they become unblocked by the operation that was just applied). Cross-dependencies allow the system to efficiently combine operations that can be combined, as described above, so that the number of operations that have to be applied to the back-end storage 228A is reduced. This has multiple benefits, such as reduced requirements for storing information in Intent Logs 250A and 260A, and improving performance by reducing the number of operations to be applied to the back-end storage 228A.

Operations from the Intent Logs 250A and 260A can be also applied (i.e., replicated) to a second, usually remote memory device B. The memory device B has components that are similar in function to the components of memory device A, and the components that serve similar functions in the respective memory devices are identified with the same reference numeral followed by the memory device identifier A or B. Cross-dependencies between operations in the Logs can be used for combining, optimizing, and correctly re-ordering the operations to the second memory device B.

When the first memory device A and the second memory device B need to be synchronized, the synchronizing process samples the objects stored on the systems in a predetermined order. The predetermined order allows the objects on each system to be sampled asynchronously for improved performance. Once sampled, the objects transition from the initial state to the final state through intermediate states that control which synchronization rules apply. Newly incoming operations are either applied locally, blocked, deferred, or applied to both the first memory device and the second memory device as determined by the applicable synchronization rule for each object. An example of the rules was described above.

Cross-dependencies between deferred operations are tracked in the way described above and are used for determining the order in which the operations are applied to the remote system. The cross-dependencies allow us to optimize the best time and the best order for performance while ensuring correct application of the operations. The cross-dependencies are also used to efficiently combine operations that enhance performance. Operations can arrive that influence multiple objects in different regions, so ghosts are used (as described above) to ensure that the sampling order is not compromised by changes to the objects.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims include such changes and modifications. It should be further apparent to those skilled in the art that the various embodiments are not necessarily exclusive, but that features of some embodiments may be combined with features of other embodiments while remaining with the spirit and scope of the invention.

For example, the concepts underlying combining a series of operations into a single operation or the management of cross-dependencies between operations may be applied to situations that do not involve synchronization or replication. For example, in U.S. patent application Ser. No. 10/866,229 filed on Jun. 10, 2004, operations are entered to persistent intent log (PIL) that are subsequently drained to the underlying file system. When determining which operations can be drained, dependencies between operations can be managed in the manner disclosed herein. Likewise, operations that are waiting to be drained can be combined into fewer operations in the manner disclosed herein.

What is claimed is:

1. A method of optimizing a stream of operations, the method comprising:
receiving a stream of operations;
analyzing cross-dependencies among the operations;
identifying a subset of the operations to be deferred and deferring the subset of the operations;
determining an optimized order for applying the subset of the operations that are deferred.

2. The method of claim 1 further comprising forming a list of deferred operations containing the subset of the operations, wherein the list identifies a cross-dependent relationship among the subset of the operations.

3. The method of claim 2 further comprising:
applying a particular deferred operation from the list of deferred operations; and
removing the particular deferred operation from the list in response to the applying.

4. The method of claim 3 further comprising applying other deferred operations on the list that were blocked by the particular deferred operation.

5. The method of claim 1 further comprising logically combining some of the operations into a single operation based on the cross-dependencies.

6. The method of claim 1 further comprising applying the subset of operations in the optimized order.

7. The method of claim 1, wherein one of the operations that is deferred is a multi-object operation having a parent object and a child object, further comprising:
adding the multi-object operation to a parent list of deferred operations for the parent object;
adding the multi-object operation to a child list of deferred operations for the child object; and
applying the multi-object operation only if the multi-object operation is not blocked by another operation in either the parent list or the child list.

8. The method of claim 7 further comprising creating separate parent lists for multi-object operations with no cross-dependency.

9. The method of claim 7 further comprising creating separate child lists for multi-object operations with no cross-dependency.

10. A method of optimizing multiple streams of operations received by one or more memory devices, the method comprising:
analyzing cross-dependencies among the operations;
identifying a subset of the operations to be deferred and deferring the subset of the operations; and
determining an optimized order for applying the subset of operations that are deferred to each of the memory devices.

11. The method of claim 10 further comprising combining some of the operations into a single operation based on cross-dependencies among the operations.

12. A method of optimizing streams of operations received by multiple memory devices having objects and corresponding objects, the method comprising:
sampling the objects in a predetermined order, wherein the sampling changes the states of the objects;
receiving an operation to be performed on at least one target object of the objects;
determining a state of the target object;
comparing the objects to the corresponding objects in the multiple memory devices;
determining a timing for applying the operation to the target object and applying the operation to the second memory device based on the state of the target object; and
applying the operation to the target object, and deferring applying the operation to the second memory device if the target object is in a revising state.

13. The method of claim 12 further comprising:
determining whether to perform a revision; and
performing the revision on the corresponding object of the second memory device to make it substantially similar to the target object in the revising state if the target object.

14. The method of claim 12, wherein the sampling is performed in a first thread, further comprising making a revision to the corresponding objects in a second thread.

15. The method of claim 12, wherein the sampling is done by a blocking region and there is a revising region that is separate from the blocking region, wherein objects that are covered by the blocking region are in a blocking state and the objects that are covered by the revising region are in a revising state.

16. The method of claim 15, wherein the blocking region and the revising region are adjacent to each other.

17. The method of claim 15 further comprising controlling a maximum number of deferred operations by adjusting a size of the revising region.

18. The method of claim 15 further comprising minimizing a size of the blocking region.

19. The method of claim 15 further comprising:
gathering object information from the memory devices while the target object is in the blocking state; and
comparing the objects to in the memory devices while the target object is in the revising state.

20. The method of claim 12 further comprising preventing changes to the target object if the target object is in a blocking state.

21. The method of claim 12, wherein the objects are in an initial state before being sampled and in a final state after being sampled, the method further comprising:
applying the operation only on the target object if the target object is in the initial state; and
applying the operation on the target object and a corresponding object in the second memory device if the target object is in the final state.

22. The method of claim 12 further comprising:
preparing the deferred operation for application in a first thread; and
applying the deferred operation in a second thread.

23. The method of claim 12, wherein deferring applying the operation to the second memory device comprises caching an object identifier.

24. The method of claim 12 further comprising identifying the predetermined order of sampling as a sequence of file identifiers.

25. The method of claim 12, wherein the predetermined order is a function of a depth or breadth of files in a file system.

26. The method of claim 12, wherein the predetermined order is a sequence of memory blocks.

27. The method of claim 12 further comprising adding a ghost entry for the target object when the operation involves a first target object that is in either a final state or a revising state and a second target object that is in an initial state, wherein the ghost entry hides an effect of the operation for the sampling.

28. The method of claim 27 further comprising deferring the operation and associating the ghost entry with the deferred operation to ensure that the operation will be performed.

29. The method of claim 27 further comprising creating a list of ghost entries for the target object where a plurality of operations are performed on the target object.

30. The method of claim 29, wherein the list of ghost entries are indexed by a parent object and each parent object has one or more lists wherein each list is specific to a child name.

31. The method of claim 12 further comprising deferring the operation until all target objects that are affected by the operation are in their final state if the operation affects more than one object.

32. The method of claim 12 further comprising:
determining if objects needed for the operation are available for the operation; and
applying the operation that was deferred in the revising state to the second memory device before the target object is in a final state.

33. The method of claim 12 further comprising adding the operation to a queue of deferred operations for the target object upon deciding to defer the operation.

34. The method of claim 33 further comprising:
removing the operation from the queue of deferred operations upon applying the operation; and
reviewing a remainder of the queue of deferred operations to identify other operations that are ready to be applied as a result of the removing.

35. The method of claim 34, wherein the reviewing comprises analyzing cross-dependencies among the other operations in the queue.

36. The method of claim 33, wherein the operation is a multi-object operation that has a parent object and a child object, further comprising:
adding the operation that is deferred to a parent list of deferred operations for the parent object; and
adding the operation that is deferred to a child list of deferred operations for the child object.

37. The method of claim 36 further comprising verifying that the operation is a first listed item on the parent list and a first listed item on the child list before applying the operation to the target objects.

38. The method of claim 36 further comprising:
creating a plurality of parent lists for the parent object; and
adding operations that do not depend on each other to separate parent lists.

39. The method of claim 36 further comprising:
creating a plurality of child lists for the child object; and
adding operations that do not depend on each other to separate child lists.

40. The method of claim 36 further comprising removing the operation from the parent list and the child list after the operation is applied.

41. The method of claim 40 further comprising, upon removing the operation, reviewing the lists of deferred operations and identifying other operations that are ready to be applied as a result of the removing.

42. The method of claim 33 further comprising removing the operation from the queue of simple operations after the operation is performed on the target object.

43. The method of claim 33 further comprising examining remaining items in the queue of deferred operations upon determining that an item in the queue is ready to be performed.

44. The method of claim 12, wherein the operation is a first operation, further comprising:
receiving a second operation after the first operation; and
logically combining the first operation and the second operation into a combined operation where the first operation and the second operation are deferred.

45. The method of claim 44, wherein logically combining the first operation and the second operation comprises analyzing a cross-dependency between the first operation and second operation.

46. A system for optimizing a stream of operations, the system comprising:
a first module for receiving a stream of operations;
a second module for analyzing cross-dependencies among the operations;
a third module for identifying a subset of the operations to be deferred and deferring the subset of the operations;
a fourth module for determining an optimized order for applying the subset of the operations that are deferred.

47. The method of claim 46 further comprising a fifth module for forming a list of deferred operations containing the subset of the operations, wherein the list identifies a cross-dependent relationship among the subset of the operations.

48. The system of claim 47, wherein the fifth module applies a particular deferred operation from the list of deferred operations and removes the particular deferred operation from the list in response to the applying.

49. The system of claim 48, wherein the fifth module applies other deferred operations on the list that were blocked by the particular deferred operation.

50. The system of claim 46 further comprising a fifth module for logically combining some of the operations into a single operation based on the cross-dependencies.

51. The system of claim 46 further comprising a fifth module for applying the subset of operations in the optimized order.

52. A system for managing data between a plurality of memory devices, the system comprising:
a first memory device having objects;
a second memory device having corresponding objects;
an input for receiving an operation to be performed on at least one target object of the objects; and
a processor that samples the objects in the first memory device, determines a state of the target object, and determines whether to perform a revision, determines a timing for applying the operation to the target object, determines a timing for applying the operation to the corresponding objects;
wherein the processor applies the operation to the target object but defers applying the operation to the corresponding objects if the target object is in a revising state.

53. The method of claim 52, wherein the process performs the revision to the corresponding objects in the revising state to make the corresponding objects substantially similar to the target object.

54. The system of claim 52 further comprising a memory for storing a list of deferred operations, wherein the operation that is deferred is added to the list.

55. The system of claim 54 further comprising a module for determining cross-dependencies among the deferred operations.

56. The system of claim 55, wherein the module removes a particular operation from the list of deferred operations upon applying the particular operation to the corresponding objects.

57. The system of claim 56, wherein the module reviews remaining deferred operations on the list upon removing the particular operation to determine if any other deferred operations is ready to be applied.

58. The system of claim 52, wherein the processor samples the objects by traversing the objects with a blocking region and a revising region, wherein an object that has not been sampled is in an initial state, an object that is covered by the blocking region is in a blocking state, an object that is covered by the revising region is in the revising state, and an object that comes out of the revising state is in a final state.

59. The system of claim 59, wherein the blocking region and the revising region are adjacent to each other.

60. The system of claim 59, wherein the processor prevents any change from being made to the target object if the target object is in the blocking state.

61. The system of claim 59, wherein the processor performs the operation only on the target object if the target object is in an initial state.

62. The system of claim 59, wherein the processor performs the operation on the target object and the corresponding objects if the target object is in the final state.

63. The system of claim 52 further comprising a memory for storing a traversal order in which the processor examines the first memory device, the traversal order being a sequence of file identifiers.

64. The system of claim 52 further comprising a memory for storing a traversal order in which the processor examines the first memory device, the traversal order being a function of depth or breadth of files in a file system.

65. The system of claim 52 further comprising a module for generating a ghost entry, wherein the processor adds the ghost entry to the target object when the target object is operated on during examination of the first memory device, wherein the ghost entry hides an effect of the operation.

66. The system of claim 65 further comprising a link between the ghost entry and the operation whose effect is hidden, wherein the operation is deferred.

67. The system of claim 65 further comprising a list of ghost entries for a parent object in a multi-object operation, wherein the list is specific to a child name and there is an additional list for the parent object that is specific to a different child name.

68. The system of claim 52, wherein the operation is a multi-object operation that has a parent object and a child object, further comprising:
a parent list of deferred operations for the parent object; and
a child list of deferred operations for the child object.

69. The system of claim 68, wherein the processor applies a deferred operation to a target object only if the deferred operation is a first item on the parent list of the parent object and a first item on the child list of the child object.

70. The system of claim 52, wherein the processor logically combines a plurality of deferred operations into a single operation.

71. The system of claim 70, wherein the processor review cross-dependencies among the plurality of deferred operations before logically combining them.

72. A computer-readable medium having computer executable instructions thereon for a method of optimizing a stream of operations, the method comprising:
receiving a stream of operations;
analyzing cross-dependencies among the operations;
identifying a subset of the operations to be deferred and deferring the subset of the operations;
determining an optimized order for applying the subset of the operations that are deferred.

73. The computer-readable medium of claim 72 further comprising forming a list of deferred operations containing the subset of the operations, wherein the list identifies a cross-dependent relationship among the subset of the operations.

74. The computer-readable medium of claim 73 further comprising:
applying a particular deferred operation from the list of deferred operations; and
removing the particular deferred operation from the list in response to the applying.

75. The computer-readable medium of claim 74 further comprising applying other deferred operations on the list that were blocked by the particular deferred operation.

76. The computer-readable medium of claim 72 further comprising logically combining some of the operations into a single operation based on the cross-dependencies.

77. The computer-readable medium of claim 72 further comprising applying the subset of operations in the optimized order.

78. The computer-readable medium of claim 72, wherein one of the operations that is deferred is a multi-object operation having a parent object and a child object, further comprising:
adding the multi-object operation to a parent list of deferred operations for the parent object;
adding the multi-object operation to a child list of deferred operations for the child object; and
applying the multi-object operation only if the multi-object operation is not blocked by another operation in either the parent list or the child list.

79. The computer-readable medium of claim 72 further comprising creating separate parent lists for multi-object operations with no cross-dependency.

80. The computer-readable medium of claim 72 further comprising creating separate child lists for multi-object operations with no cross-dependency.

81. A computer-readable medium having computer executable instructions thereon for a method of optimizing multiple streams of operations received by one or more memory devices, the method comprising:
analyzing cross-dependencies among the operations;
identifying a subset of the operations to be deferred and deferring the subset of the operations; and
determining an optimized order for applying the subset of operations that are deferred to each of the memory devices.

82. A computer-readable medium having computer executable instructions thereon for a method of optimizing streams of operations received by multiple memory devices having objects and corresponding objects, the method comprising:
sampling the objects in a predetermined order, wherein the sampling changes the states of the objects;
receiving an operation to be performed on at least one target object of the objects;
determining a state of the target object;
comparing the objects to the corresponding objects in the multiple memory devices;
determining a timing for applying the operation to the target object and applying the operation to the second memory device based on the state of the target object; and
applying the operation to the target object, and deferring applying the operation to the second memory device if the target object is in a revising state.

83. The computer-readable medium of claim 82, the method further comprising:
determining whether to perform a revision; and
performing the revision on the corresponding object of the second memory device to make it substantially similar to the target object in the revising state if the target object.

84. The computer-readable medium of claim 82, wherein the sampling is performed in a first thread, further comprising making a revision to the corresponding objects in a second thread.

85. The computer-readable medium of claim 82, wherein the sampling is done by a blocking region, and wherein there is a revising region that is separate from the blocking region, wherein objects that are covered by the blocking region are in a blocking state and the objects that are covered by the revising region are in a revising state.

86. The computer-readable medium of claim 85, wherein the blocking region and the revising region are adjacent to each other.

87. The computer-readable medium of claim 85, the method further comprising controlling a maximum number of deferred operations by adjusting a size of the revising region.

88. The computer-readable medium of claim 85, the method further comprising minimizing a size of the blocking region.

89. The computer-readable medium of claim 85, the method further comprising:
gathering object information from the memory devices while the target object is in the blocking state; and
comparing the objects to the corresponding objects in the second memory device while the objects are in the revising state.

90. The computer-readable medium of claim 82, the method further comprising preventing changes to the target object if the target object is in a blocking state.

91. The computer-readable medium of claim 82, wherein the objects are in an initial state before being sampled and in a final state after being sampled, the method further comprising:
applying the operation only on the target object if the target object is in the initial state; and
applying the operation on the target object and a corresponding object in the second memory device if the target object is in the final state.

92. The computer-readable medium of claim 82, the method further comprising:
preparing the deferred operation for application in a first thread; and
applying the deferred operation in a second thread.

93. The computer-readable medium of claim 82, wherein deferring applying the operation to the second memory device comprises caching an object identifier.

94. The computer-readable medium of claim 82, the method further comprising identifying the predetermined order of sampling as a sequence of file identifiers.

95. The computer-readable medium of claim 82, wherein the predetermined order is a function of a depth or breadth of files in a file system.

96. The computer-readable medium of claim 82, wherein the predetermined order is a sequence of memory blocks.

97. The computer-readable medium of claim 82, the method further comprising adding a ghost entry for the target object when the operation involves a first target object that is in either a final state or a revising state and a second target object that is in an initial state, wherein the ghost entry hides an effect of the operation for the sampling.

98. The computer-readable medium of claim 97, the method further comprising deferring the operation and associating the ghost entry with the deferred operation to ensure that the operation will be performed.

99. The computer-readable medium of claim 97, the method further comprising creating a list of ghost entries for the target object where a plurality of operations are performed on the target object.

100. The computer-readable medium of claim 99, wherein the list of ghost entries are indexed by a parent object and each parent object has one or more lists wherein each list is specific to a child name.

101. The computer-readable medium of claim 82, the method further comprising deferring the operation until all target objects that are affected by the operation are in their final state if the operation affects more than one object.

102. The computer-readable medium of claim 82, the method further comprising:
determining if objects needed for the operation are available for the operation; and
applying the operation that was deferred in the revising state to the second memory device before the target object is in a final state.

103. The computer-readable medium of claim 82, the method further comprising adding the operation to a queue of deferred operations for the target object upon deciding to defer the operation.

104. The computer-readable medium of claim 103, the method further comprising:
removing the operation from the queue of deferred operations upon applying the operation; and
reviewing a remainder of the queue of deferred operations to identify other operations that are ready to be applied as a result of the removing.

105. The computer-readable medium of claim 104, wherein the reviewing comprises analyzing cross-dependencies among the other operations in the queue.

106. The computer-readable medium of claim 103, wherein the operation is a multi-object operation that has a parent object and a child object, further comprising:
adding the operation that is deferred to a parent list of deferred operations for the parent object; and
adding the operation that is deferred to a child list of deferred operations for the child object.

107. The computer-readable medium of claim 106, the method further comprising verifying that the operation is a first listed item on the parent list and a first listed item on the child list before applying the operation to the target objects.

108. The computer-readable medium of claim 106, the method further comprising:
creating a plurality of parent lists for the parent object; and
adding operations that do not depend on each other to separate parent lists.

109. The computer-readable medium of claim 106, the method further comprising:
creating a plurality of child lists for the child object; and
adding operations that do not depend on each other to separate child lists.

110. The computer-readable medium of claim 106, the method further comprising removing the operation from the parent list and the child list after the operation is applied.

111. The computer-readable medium of claim 110, the method further comprising, upon removing the operation, reviewing the lists of deferred operations and identifying other operations that are ready to be applied as a result of the removing.

112. The computer-readable medium of claim 103, the method further comprising removing the operation from the queue of simple operations after the operation is performed on the target object.

113. The computer-readable medium of claim 103, the method further comprising examining remaining items in the queue of deferred operations upon determining that an item in the queue is ready to be performed.

114. The computer-readable medium of claim 82, wherein the operation is a first operation, further comprising:
receiving a second operation after the first operation; and
logically combining the first operation and the second operation into a combined operation where the first operation and the second operation are deferred.

115. The computer-readable medium of claim 114, wherein logically combining the first operation and the second operation comprises analyzing a cross-dependency between the first operation and second operation.
